(19) United States
(12) Patent Application Publication
(10) Pub. No.: US 2018/0213345 A1
(43) Pub. Date: Jul. 26, 2018

(54) Multi-Apparatus Distributed Media Capture for Playback Control

(71) Applicant: Nokia Technologies Oy, Espoo (FI)

(72) Inventors: Sujeet Shyamsundar MATE, Tampere (FI); Veli-Matti KOLMONEN, Espoo (FI); Antti ERONEN, Tampere (FI); Arto LEHTINIEMI, Lempaala (FI)

(21) Appl. No.: 15/742,687

(22) PCT Filed: Jul. 5, 2016
(86) PCT No.: PCT/FI2016/050496

§ 371 Date: Jan. 8, 2018

(30) Foreign Application Priority Data
Jul. 8, 2015 (GB) 1511949.8
Jul. 27, 2015 (GB) 1513198.0
Oct. 12, 2015 (GB) 1518023.5
Oct. 12, 2015 (GB) 1518025.0
Nov. 30, 2015 (GB) 1521096.6

(51) Int. Cl. H04S 7/00; H04R 5/027; G06T 7/70

(52) U.S. Cl. CPC H04S 7/303; H04R 5/027; H04S 2400/15; H04S 2400/11; G06T 7/70

(57) ABSTRACT

Apparatus for capturing media including: a first media capture device configured to capture media; a locator configured to receive at least one remote location signal such that the apparatus is configured to locate an audio source associated with a tag generating the remote location signals, the locator including an array of antenna elements arranged with a reference orientation from which the tag is located; and a common orientation determiner configured to determine a common datum orientation between the reference orientation and the common datum, the common datum being common with respect to the apparatus and at least one further apparatus for capturing media, such that switching between the apparatus and the further apparatus for capturing media can be controlled based on the determined common datum orientation and a further apparatus common datum orientation.

### FIELD

The present application relates to apparatus and methods for distributed audio capture and mixing. The invention further relates to, but is not limited to, apparatus and methods for distributed audio capture and mixing for spatial processing of audio signals to enable spatial reproduction of audio signals.

### BACKGROUND

Capture of audio signals from multiple sources and mixing of those audio signals when these sources are moving in the spatial field requires significant manual effort. For example the capture and mixing of an audio signal source such as a speaker or artist within an audio environment such as a theatre or lecture hall to be presented to a listener and produce an effective audio atmosphere requires significant investment in equipment and training.

A commonly implemented system would be for a professional producer to utilize a close microphone, for example a Lavalier microphone worn by the user or a microphone attached to a boom pole to capture audio signals close to the speaker or other sources, and then manually mix this captured audio signal with one or more suitable spatial (or environmental or audio field) audio signals such that the produced sound comes from an intended direction.

The spatial capture apparatus or omni-directional content capture (OCC) devices should be able to capture high quality audio signal while being able to track the close microphones.

However a single point omni-directional content capture (OCC) apparatus can be problematic in that it provides an all aspect view but from only a single point in space.

### SUMMARY

According to a first aspect there is provided apparatus for capturing media comprising: a first media capture device configured to capture media; a locator configured to receive at least one remote location signal such that the apparatus is configured to locate an audio source associated with a tag generating the remote location signals, the locator comprising an array of antenna elements arranged with a reference orientation from which the tag is located; and a common orientation determiner configured to determine a common datum orientation between the reference orientation and the common datum, the common datum being common with respect to the apparatus and at least one further apparatus for capturing media, such that switching between the apparatus and the further apparatus for capturing media can be controlled based on the determined common datum orientation and a further apparatus common datum orientation.

The media capture device may comprise at least one of: a microphone array configured to capture at least one spatial audio signal comprising an audio source, the microphone array comprising at least two microphones arranged around a first axis and configured to capture an audio source along the reference orientation; and at least one camera configured to capture an image with a field of view including the reference orientation.

The locator may be a radio based positioning locator and wherein the at least one remote location signal may be a radio based positioning tag signal.

The locator may be configured to transmit the common datum orientation associated with the apparatus to a server, wherein the server may be configured to determine an offset orientation between pairs of apparatus for capturing media based on the common datum orientation of the apparatus and the further apparatus common datum orientation.

The locator may be configured to locate an audio source associated with a tag based on the reference orientation from which the tag is located and the common datum orientation so to generate an audio source location orientation relative to the common datum.

The media capture device may have a capture reference orientation which is offset with respect to the reference orientation associated with the locator antenna elements.

The common orientation determiner may comprise: an electronic compass configured to determine the common datum orientation between the reference orientation and magnetic north; a beacon orientation determiner configured to determine the common datum orientation between the reference orientation and a radio or light beacon; and a gps orientation determiner configured to determine the common datum orientation between the reference orientation and a determined gps derived position.

According to a second aspect there is provided an apparatus for playback control of the captured media, the apparatus configured to: receive, from each of the more than one apparatus for capturing media, a common datum orientation between a reference orientation of the respective apparatus for capturing media and a common datum, the common datum being common with respect to the more than apparatus for capturing media; and determine an offset orientation between pairs of apparatus for capturing media based on the common datum orientations.

The apparatus may furthermore be configured to provide the offset orientation to a playback apparatus to enable the playback apparatus to control a switch between the more than one apparatus.

The apparatus may further be configured to receive captured media from more than one apparatus wherein the apparatus may be further configured to process the captured media from the more than one apparatus based on the offset orientation when implementing a switch from the first of the pair of apparatus for capturing media to the other.

The apparatus may be further configured to: receive location estimates for audio sources from the more than one apparatus for capturing media; determine a switching policy associated with a switch between a pair of apparatus for capturing media; and apply the switching policy to the location estimates for audio sources.

The switching policy may comprise one or more of the following: maintain a location orientation for an object of interest after a switch; and keep an object of interest within a field of experience after a switch.

A system may comprise: a first apparatus as described herein; a further apparatus for capturing media comprising: a further media capture device configured to capture media; a further locator configured to receive at least one remote location signal such that the further apparatus is configured to locate an audio source associated with a tag generating the remote location signals, the further locator comprising an array of antenna elements arranged with a reference orientation from which the tag is located; and a further common orientation determiner configured to determine a further common datum orientation between the further apparatus reference orientation and the common datum, the common datum being common with respect to the further apparatus and the apparatus for capturing media, such that switching between the apparatus and the further apparatus for capturing media can be controlled based on the determined common datum orientation and a further apparatus common datum orientation.

The system may further comprise at least one remote media capture apparatus, the at least one remote media capture apparatus may comprise: at least one remote media capture apparatus configured to capture media associated with the audio source; and a locator tag configured to transmit remote location signal.

The system may further comprise a playback control server, the playback control server may comprise: an offset determiner configured to determine an offset orientation between the apparatus for capturing media common datum orientation and the further apparatus for capturing media common datum orientation.

According to a third aspect there is provided a method for capturing media, the method comprising: capturing media using a first media capture device; receiving at least one remote location signal; locating an audio source associated with a tag generating the remote location signal, the location associated with a reference orientation from which the tag is located; determining a common datum orientation between the reference orientation and a common datum, the common datum being common with respect to the first capture device and at least one apparatus for capturing media; and controlling switching between the device media and the apparatus for capturing media based on the determined common datum orientation and a further apparatus common datum orientation.

Capturing media may comprise at least one of: capturing at least one spatial audio signal comprising an audio source using a microphone array comprising at least two microphones arranged around a first axis and configured to capture an audio source along the reference orientation; and capturing an image using at least one camera with a field of view including the reference orientation.

Locating an audio source may comprise radio based positioning locating and wherein the at least one remote location signal may be a radio based positioning tag signal.

Locating an audio source may comprise transmitting the common datum orientation associated with the apparatus to a server, wherein the method may further comprise determining at the server an offset orientation between pairs of apparatus for capturing media based on the common datum orientation and apparatus common datum orientation.

Locating an audio source may comprise locating an audio source associated with a tag based on the reference orientation from which the tag is located and the common datum orientation so to generate an audio source location orientation relative to the common datum.

Capturing media using a first media capture device may comprise capturing media using a first media device with a capture reference orientation which is offset with respect to the reference orientation.

Determining a common datum orientation may comprise: determining the common datum orientation between the reference orientation and magnetic north; determining the common datum orientation between the reference orientation and a radio or light beacon; and determining the common datum orientation between the reference orientation and a determined gps derived position.

According to a fourth aspect there is provided a method for playback control of the captured media, the method comprising: receiving, from each of the more than one apparatus for capturing media, a common datum orientation between a reference orientation of the respective apparatus for capturing media and a common datum, the common datum being common with respect to the more than apparatus for capturing media; and determining an offset orientation between pairs of apparatus for capturing media based on the common datum orientations.

The method may comprise providing the offset orientation to a playback apparatus to enable the playback apparatus to control a switch between the more than one apparatus.

The method may further comprise: receiving captured media from more than one apparatus; processing the captured media from the more than one apparatus based on the offset orientation when implementing a switch from the first of the pair of apparatus for capturing media to the other.

The method may further comprise: receiving location estimates for audio sources from the more than one apparatus for capturing media; determining a switching policy associated with a switch between a pair of apparatus for capturing media; and applying the switching policy to the location estimates for audio sources.

Determining a switching policy may comprise one or more of the following: maintaining a location orientation for an object of interest after a switch; and keeping an object of interest within a field of experience after a switch.

According to a fifth aspect there is provided an apparatus for capturing media, the apparatus comprising: means for capturing media using a first media capture device; means for receiving at least one remote location signal; means for locating an audio source associated with a tag generating the remote location signal, the location associated with a reference orientation from which the tag is located; means for determining a common datum orientation between the reference orientation and a common datum, the common datum being common with respect to the first capture device and at least one apparatus for capturing media; and means for controlling switching between the device media and the apparatus for capturing media based on the determined common datum orientation and a further apparatus common datum orientation.

The means for capturing media may comprise at least one of: means for capturing at least one spatial audio signal comprising an audio source using a microphone array comprising at least two microphones arranged around a first axis and configured to capture an audio source along the reference orientation; and means for capturing an image using at least one camera with a field of view including the reference orientation.

The means for locating an audio source may comprise means for radio based positioning locating and wherein the at least one remote location signal may be an radio based positioning tag signal.

The means for locating an audio source may comprise means for transmitting the common datum orientation associated with the apparatus to a server, wherein the server is configured to determine an offset orientation between pairs of apparatus for capturing media based on the common datum orientation and apparatus common datum orientation.

The means for locating an audio source may comprise means for locating an audio source associated with a tag based on the reference orientation from which the tag is located and the common datum orientation so to generate an audio source location orientation relative to the common datum.

The means for capturing media using a first media capture device may comprise means for capturing media using a first media device with a capture reference orientation which is offset with respect to the reference orientation.

The means for determining a common datum orientation may comprise: means for determining the common datum orientation between the reference orientation and magnetic north; means for determining the common datum orientation between the reference orientation and a radio or light beacon; and means for determining the common datum orientation between the reference orientation and a determined gps derived position.

According to a sixth aspect there is provided an apparatus for playback control of the captured media, the apparatus comprising: means for receiving, from each of the more than one apparatus for capturing media, a common datum orientation between a reference orientation of the respective apparatus for capturing media and a common datum, the common datum being common with respect to the more than apparatus for capturing media; and means for determining an offset orientation between pairs of apparatus for capturing media based on the common datum orientations.

The apparatus may comprise means for providing the offset orientation to a playback apparatus to enable the playback apparatus to control a switch between the more than one apparatus.

The apparatus may further comprise: means for receiving captured media from more than one apparatus; means for processing the captured media from the more than one apparatus based on the offset orientation when implementing a switch from the first of the pair of apparatus for capturing media to the other.

The apparatus may further comprise: means for receiving location estimates for audio sources from the more than one apparatus for capturing media; means for determining a switching policy associated with a switch between a pair of apparatus for capturing media; and means for applying the switching policy to the location estimates for audio sources.

The means for determining a switching policy may comprise one or more of the following: means for maintaining a location orientation for an object of interest after a switch; and means for keeping an object of interest within a field of experience after a switch.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIGS. 1a to 1c show example OCC apparatus distributed over a venue according to some embodiments;

FIG. 2 shows example OCC apparatus distributed and a tracked object of interest or positioning tag over a venue according to some embodiments;

FIGS. 3 to 5 shows example OCC apparatus offset management according to some embodiments;

FIGS. 6 and 7 show example OCC apparatus distributions according to some embodiments;

FIG. 8 shows a flow diagram of an example object of interest based switching of OCC apparatus according to some embodiments; and

FIG. 9 shows schematically capture and render apparatus suitable for implementing spatial audio capture and rendering according to some embodiments; and

FIG. 10 shows schematically an example device suitable for implementing the capture and/or render apparatus shown in FIG. 9.

### EMBODIMENTS OF THE APPLICATION

The following describes in further detail suitable apparatus and possible mechanisms for the provision of effective capture of audio signals from multiple sources and mixing of those audio signals. In the following examples, audio signals and audio capture signals are described. However it would be appreciated that in some embodiments the apparatus may be part of any suitable electronic device or apparatus configured to capture an audio signal or receive the audio signals and other information signals.

As described previously a conventional approach to the capturing and mixing of audio sources with respect to an audio background or environment audio field signal would be for a professional producer to utilize an external or close microphone (for example a Lavalier microphone worn by the user or a microphone attached to a boom pole) to capture audio signals close to the audio source, and further utilize a omnidirectional object capture microphone to capture an environmental audio signal. These signals or audio tracks may then be manually mixed to produce an output audio signal such that the produced sound features the audio source coming from an intended (though not necessarily the original) direction.

As would be expected this requires significant time and effort and expertise to do correctly. Furthermore in order to cover a large venue, multiple points of omni-directional capture are needed to create a holistic coverage of the event. More specifically, multiple OCC apparatus are required as described in further detail herein to cover a large space.

Furthermore by implementing multiple OCC apparatus configured to enable multiple instances of capture points is that each of the OCC apparatus has its own reference or “Front” direction. Consequently, when switching from one OCC to another one, there is the need to identify and store all the reference or “Front” directions. If this is not done, moving from one OCC capture point to another may experience a sudden change in orientation while consuming (for example listening to) the content.

The concept as described herein may make it possible to capture and remix an external or close audio signal and spatial or environmental audio signal more effectively and efficiently.

The concept as discussed in the following embodiments relates to a method to determine and signal the relative reference ‘Front’ orientation offsets between multiple omni-directional content capture (OCC) apparatus or devices. In the following embodiments media or media content may refer to audio, video or both. The relative orientation offsets between the multiple OCC devices may be signalled to enable media content adaptation for seamless traversal between OCC apparatus.

As described herein the reference orientation of each OCC apparatus is known to itself. The concept as discussed herein is for each OCC apparatus to determine a common datum orientation (for example by using a magnetic compass to determine magnetic north), and then determine the offset of the OCC apparatus with respect to the determined common datum reference orientation. Although the following examples show the determination of a common datum reference orientation using an electronic compass other common datum reference methods may be employed. For example where street view images (e.g. Navteq or Here street view images) are available, or by visual analysis based Global CPE can be used to determine the offset from the common datum. Furthermore common references may be provided by exploiting an artificial reference beacon over a pre-specific IP address or radio channel. Outdoor common references furthermore may use a GPS or other signal at ‘infinity’. This information can then be signalled from the OCC apparatus to a suitable device and combined to determine the relative offsets of each OCC apparatus with respect to each other. The relative offsets between each OCC apparatus may furthermore be signalled to the entity which is delivering the media content for consumption. This entity may use the offset values to adapt the content playback orientation. The sensor based orientation offset measurement may thus be used to enable fast visual analysis based camera pose estimation and consequently, achieve fast visual calibration between the OCC apparatus.

Furthermore in some embodiments there may be an object of interest (OOI) based switching policy. In such embodiments a common reference point can be used to determine the object or region of interest and the consequent content playback selection of playback starting direction for the user, which ensures that a particular object is in view when switching from one OCC apparatus to another one. For example, in case of OOI tracking with radio based positioning—such as HAIP (High Accuracy Indoor Positioning) location determination system, the direction of arrival for a particular positioning tag for each OCC apparatus can be used to choose the playback orientation. In some embodiments visual analysis or spatial audio analysis based selection of start playback direction when switching between OCC devices can be implemented.

In some embodiments furthermore the OCC apparatus comprises a microphone array part comprising a microphone array. The microphone array may then be mounted on a fixed or telescopic mount which locates the microphone array, with a ‘front’ or reference orientation relative to a locator (an locator such as high accuracy indoor positioning—HAIP) part. The OCC apparatus further comprises a locator part. The locator part may comprise an array of positioning receivers. Each array element may be located and orientated on the same elevation plane (for example centred on the horizontal plane) and positioned about (for example for a 3 element array 120 degrees separate) in azimuth from each other in order to provide 360 degree coverage with some overlap. The reference orientation of the microphone array may be coincidental with the reference orientation of one of the receiver array elements. However in some embodiments the microphone reference orientation is defined relative to a reference orientation of one of the receiver array elements. Thus in some embodiments the OCC apparatus comprises a co-axially located microphone array and locator. The co-axial location as well as aligned reference axis of the locator and the media capture system enable simple out of box usage as the configuration shown herein may remove the need for any calibration or complicated setup.

In some embodiments the relative reference orientation information between OCC apparatus may be signalled at a suitable frequency when one or more of the OCC apparatus are moving.

In some embodiments a suitable metadata description format (e.g. SDP/JSON/PROTOBUF/etc) over a suitable transport protocol (HTTP/UDP/TCP/etc) can be used to signal the reference information.

The concept may for example be embodied as a capture system configured to capture both an external or close (speaker, instrument or other source) audio signal and a spatial (audio field) audio signal. The capture system may furthermore be configured to determine or classify a source and/or the space within which the source is located. This information may then be stored or passed to a suitable rendering system which having received the audio signals and the information may use this information to generate a suitable mixing and rendering of the audio signal to a user. Furthermore in some embodiments, the render system may enable the user to input a suitable input to control the mixing, for example by use of a headtracking or other input which causes the mixing to be changed.

The concept furthermore is embodied by a broad spatial range capture device or an omni-directional content capture (OCC) apparatus or device.

Although the capture and render systems in the following examples are shown as being separate, it is understood that they may be implemented with the same apparatus or may be distributed over a series of physically separate but communication capable apparatus. For example, a presence-capturing device such as the Nokia OZO device could be equipped with an additional interface for analysing external microphone sources, and could be configured to perform the capture part. The output of the capture part could be a spatial audio capture format (e.g. as a 5.1 channel downmix), the Lavalier sources which are time-delay compensated to match the time of the spatial audio, and other information such as the classification of the source and the space within which the source is found.

In some embodiments the raw spatial audio captured by the array microphones (instead of spatial audio processed into 5.1) may be transmitted to the mixer and renderer and the mixer/renderer perform spatial processing on these signals.

The playback apparatus as described herein may be a set of headphones with a motion tracker, and software capable of presenting binaural audio rendering. With head tracking, the spatial audio can be rendered in a fixed orientation with regards to the earth, instead of rotating along with the person's head.

Furthermore it is understood that at least some elements of the following capture and render apparatus may be implemented within a distributed computing system such as known as the ‘cloud’.

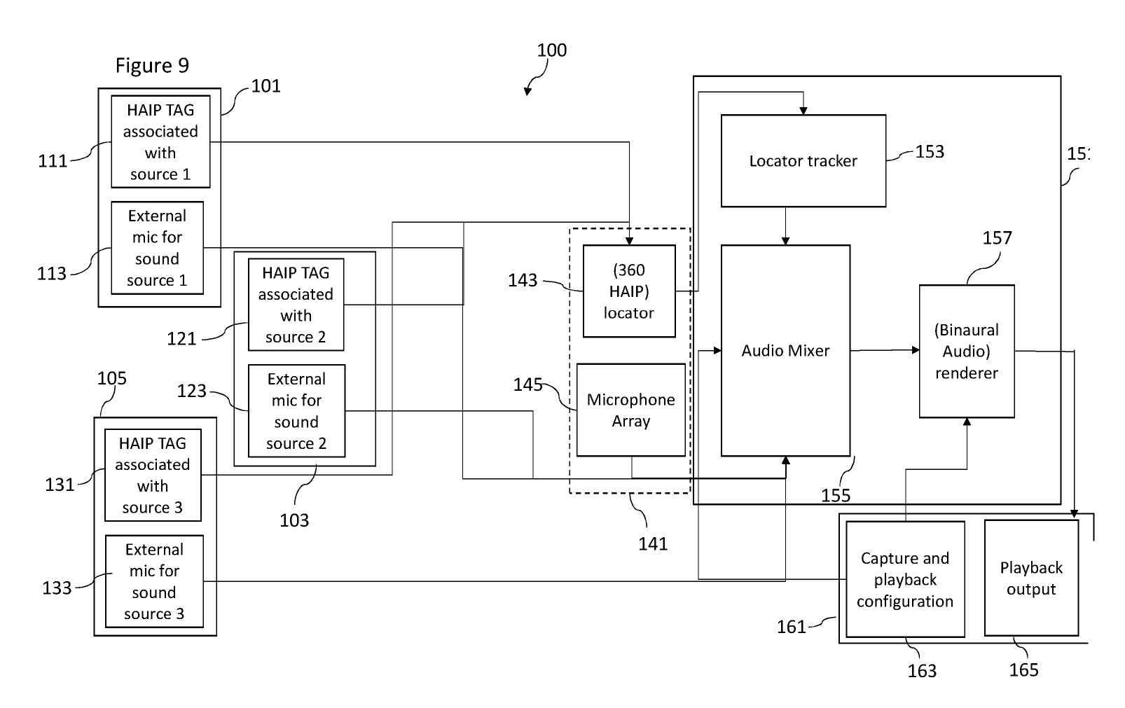

With respect to FIG. 9 is shown a system comprising local capture apparatus 101, 103 and 105, a single omni-directional content capture (OCC) apparatus 141, mixer/render 151 apparatus, and content playback 161 apparatus suitable for implementing audio capture, rendering and playback according to some embodiments.

In this example there is shown only three local capture apparatus 101, 103 and 105 configured to generate three local audio signals, however more than or fewer than 3 local capture apparatus may be employed.

The first local capture apparatus 101 may comprise a first external (or Lavalier) microphone 113 for sound source 1. The external microphone is an example of a ‘close’ audio source capture apparatus and may in some embodiments be a boom microphone or similar neighbouring microphone capture system.

Although the following examples are described with respect to an external microphone as a Lavalier microphone the concept may be extended to any microphone external or separate to the omni-directional content capture (OCC) apparatus. Thus the external microphones may be Lavalier microphones, hand held microphones, mounted mics, or whatever. The external microphones can be worn/carried by persons or mounted as close-up microphones for instruments or a microphone in some relevant location which the designer wishes to capture accurately. The external microphone 113 may in some embodiments be a microphone array.

A Lavalier microphone typically comprises a small microphone worn around the ear or otherwise close to the mouth. For other sound sources, such as musical instruments, the audio signal may be provided either by a Lavalier microphone or by an internal microphone system of the instrument (e.g., pick-up microphones in the case of an electric guitar).

The external microphone 113 may be configured to output the captured audio signals to an audio mixer and renderer 151 (and in some embodiments the audio mixer 155). The external microphone 113 may be connected to a transmitter unit (not shown), which wirelessly transmits the audio signal to a receiver unit (not shown).

Furthermore the first local capture apparatus 101 comprises a position tag 111. The position tag 111 may be configured to provide information, such as direction, range, and ID, identifying the position or location of the first capture apparatus 101 and the external microphone 113.

It is important to note that microphones worn by people can freely move in the acoustic space and the system supporting location sensing of wearable microphone has to support continuous sensing of user or microphone location. The position tag 111 may thus be configured to output the tag signal to a position locator 143. The positioning system may utilize any suitable radio technology, such as Bluetooth Low Energy, WiFi, or some other.

In the example as shown in FIG. 9, a second local capture apparatus 103 comprises a second external microphone 123 for sound source 2 and furthermore a position tag 121 for identifying the position or location of the second local capture apparatus 103 and the second external microphone 123.

Furthermore a third local capture apparatus 105 comprises a third external microphone 133 for sound source 3 and furthermore a position tag 131 for identifying the position or location of the third local capture apparatus 105 and the third external microphone 133.

In the following examples the positioning system and the tag may employ High Accuracy Indoor Positioning (HAIP) or another suitable indoor positioning technology. In the HAIP technology, as developed By Nokia, Bluetooth Low Energy is utilized. The positioning technology may also be based on other radio systems, such as WiFi, or some proprietary technology. The positioning system in the examples is based on direction of arrival estimation where antenna arrays are being utilized.

There can be various realizations of the positioning system and an example of which is the radio based location or positioning system described here. The location or positioning system may in some embodiments be configured to output a location (for example, but not restricted, in azimuth plane, or azimuth domain) and distance based location estimate.

For example, GPS is a radio based system where the time-of-flight may be determined very accurately. This, to some extent, can be reproduced in indoor environments using WiFi signaling.

The described system however may provide angular information directly, which in turn can be used very conveniently in the audio solution.

In some example embodiments the location can be determined or the location by the tag can be assisted by using the output signals of the plurality of microphones and/or plurality of cameras.

The capture apparatus 101 comprises an omni-directional content capture (OCC) apparatus 141. The omni-directional content capture (OCC) apparatus 141 is an example of an ‘audio field’ capture apparatus. In some embodiments the omni-directional content capture (OCC) apparatus 141 may comprise a directional or omnidirectional microphone array 145. The omni-directional content capture (OCC) apparatus 141 may be configured to output the captured audio signals to the mixer/render apparatus 151 (and in some embodiments an audio mixer 155).

Furthermore the omni-directional content capture (OCC) apparatus 141 comprises a source locator 143. The source locator 143 may be configured to receive the information from the position tags 111, 121, 131 associated with the audio sources and identify the position or location of the local capture apparatus 101, 103, and 105 relative to the omni-directional content capture apparatus 141. The source locator 143 may be configured to output this determination of the position of the spatial capture microphone to the mixer/render apparatus 151 (and in some embodiments a position tracker or position server 153). In some embodiments as discussed herein the source locator receives information from the positioning tags within or associated with the external capture apparatus. In addition to these positioning tag signals, the source locator may use video content analysis and/or sound source localization to assist in the identification of the source locations relative to the OCC apparatus 141.

As shown in further detail, the source locator 143 and the microphone array 145 are co-axially located. In other words the relative position and orientation of the source locator 143 and the microphone array 145 is known and defined.

In some embodiments the source locator 143 is a common orientation reference determined position determiner. The common orientation reference determined position determiner is configured to receive the positioning locator tags from the external capture apparatus and furthermore determine the location and/or orientation of the OCC apparatus 141 in order to be able to determine a position or location from the tag information which is relative to the OCC location and the common datum orientation. In other words a (positioning) locator may provide a relative position with respect to it's own mounting position. Since the (positioning) locator may be coaxially positioned with the OCC, any relative position of the external capture apparatus is available.

In some embodiments the omni-directional content capture (OCC) apparatus 141 may implement at least some of the functionality within a mobile device.

The omni-directional content capture (OCC) apparatus 141 is thus configured to capture spatial audio, which, when rendered to a listener, enables the listener to experience the sound field as if they were present in the location of the spatial audio capture device.

The local capture apparatus comprising the external microphone in such embodiments is configured to capture high quality close-up audio signals (for example from a key person's voice, or a musical instrument).

The mixer/render apparatus 151 may comprise a position tracker (or position server) 153. The position tracker 153 may be configured to receive the relative positions from the omni-directional content capture (OCC) apparatus 141 (and in some embodiments the source locator 143) and be configured to output parameters to an audio mixer 155.

Thus in some embodiments the position or location of the OCC apparatus is determined. The location of the spatial audio capture device may be denoted (at time t=0) as

(x_{S}(0),y_{S}(0))

In some embodiments

The position tracker may thus determine an azimuth angle α and the distance d with respect to the OCC and the microphone array.

For example given an external (Lavalier) microphone position at time t

(x_{L}(t),y_{L}(t))

The direction relative to the array is defined by the vector

(x_{L}(t)−x_{S}(0),y_{L}(t)−y_{S}(0))

The azimuth a may then be determined as

α=α tan 2(y_{L}(t)−y_{S}(0),x_{L}(t)−x_{S}(0))−α tan 2(y_{L}(0)−y_{S}(0),x_{L}(0),x_{S}(0))

where α tan 2(y,x) is a “Four-Quadrant Inverse Tangent” which gives the angle between the positive x-axis and the point (x,y) and the common datum orientation may be denoted as

(x_{L}(0),y_{L}(0))

Thus, the first term gives the angle between the positive x-axis (origin at x_{S}(0) and y_{S}(0)) and the point (x_{L}(t), y_{L}(t)) and the second term is the angle between the x-axis and the common datum orientation position (x_{L}(0), y_{L}(0)). The azimuth angle may be obtained by subtracting the first angle from the second.

The distance d can be obtained as

{square root over ((x_{L}(t)−x_{S}(0))²+(y(t)−y_{S}(0))²)}

In some embodiments, since the positioning location data may be noisy, the position (x_{S}(0), y_{S}(0) may be obtained by recording the positions of the positioning tags of the audio capture device and the external (Lavalier) microphone over a time window of some seconds (for example 30 seconds) and then averaging the recorded positions to obtain the inputs used in the equations above.

In some embodiments the calibration phase may be initialized by the OCC apparatus being configured to output a speech or other instruction to instruct the user(s) to stay in front of the array for the 30 second duration, and give a sound indication after the period has ended.

Although the examples shown above show the locator 145 generating location or position information in two dimensions it is understood that this may be generalized to three dimensions, where the position tracker may determine an elevation angle or elevation offset as well as an azimuth angle and distance.

In some embodiments other position locating or tracking means can be used for locating and tracking the moving sources. Examples of other tracking means may include inertial sensors, radar, ultrasound sensing, Lidar or laser distance meters, and so on.

In some embodiments, visual analysis and/or audio source localization are used to assist positioning.

Visual analysis, for example, may be performed in order to localize and track pre-defined sound sources, such as persons and musical instruments. The visual analysis may be applied on panoramic video which is captured along with the spatial audio. This analysis may thus identify and track the position of persons carrying the external microphones based on visual identification of the person. The advantage of visual tracking is that it may be used even when the sound source is silent and therefore when it is difficult to rely on audio based tracking. The visual tracking can be based on executing or running detectors trained on suitable datasets (such as datasets of images containing pedestrians) for each panoramic video frame. In some other embodiments tracking techniques such as kalman filtering and particle filtering can be implemented to obtain the correct trajectory of persons through video frames. The location of the person with respect to the front direction of the panoramic video, coinciding with the front direction of the spatial audio capture device, can then be used as the direction of arrival for that source. In some embodiments, visual markers or detectors based on the appearance of the Lavalier microphones could be used to help or improve the accuracy of the visual tracking methods.

In some embodiments visual analysis can not only provide information about the 2D position of the sound source (i.e., coordinates within the panoramic video frame), but can also provide information about the distance, which is proportional to the size of the detected sound source, assuming that a “standard” size for that sound source class is known. For example, the distance of ‘any’ person can be estimated based on an average height. Alternatively, a more precise distance estimate can be achieved by assuming that the system knows the size of the specific sound source. For example the system may know or be trained with the height of each person who needs to be tracked.

In some embodiments the 3D or distance information may be achieved by using depth-sensing devices. For example a ‘Kinect’ system, a time of flight camera, stereo cameras, or camera arrays, can be used to generate images which may be analyzed and from image disparity from multiple images a depth may or 3D visual scene may be created. These images may be generated by a camera.

Audio source position determination and tracking can in some embodiments be used to track the sources. The source direction can be estimated, for example, using a time difference of arrival (TDOA) method. The source position determination may in some embodiments be implemented using steered beamformers along with particle filter-based tracking algorithms.

In some embodiments audio self-localization can be used to track the sources.

There are technologies, in radio technologies and connectivity solutions, which can furthermore support high accuracy synchronization between devices which can simplify distance measurement by removing the time offset uncertainty in audio correlation analysis. These techniques have been proposed for future WiFi standardization for the multichannel audio playback systems.

In some embodiments, position estimates from positioning, visual analysis, and audio source localization can be used together, for example, the estimates provided by each may be averaged to obtain improved position determination and tracking accuracy. Furthermore, in order to minimize the computational load of visual analysis (which is typically much “heavier” than the analysis of audio or positioning signals), visual analysis may be applied only on portions of the entire panoramic frame, which correspond to the spatial locations where the audio and/or positioning analysis sub-systems have estimated the presence of sound sources.

Location or position estimation can, in some embodiments, combine information from multiple sources and combination of multiple estimates has the potential for providing the most accurate position information for the proposed systems. However, it is beneficial that the system can be configured to use a subset of position sensing technologies to produce position estimates even at lower resolution.

The mixer/render apparatus 151 may furthermore comprise an audio mixer 155. The audio mixer 155 may be configured to receive the audio signals from the external microphones 113, 123, and 133 and the omni-directional content capture (OCC) apparatus 141 microphone array 145 and mix these audio signals based on the parameters (spatial and otherwise) from the position tracker 153. The audio mixer 155 may therefore be configured to adjust the gain and spatial position associated with each audio signal in order to provide the listener with a much more realistic immersive experience. In addition, it is possible to produce more point-like auditory objects, thus increasing the engagement and intelligibility. The audio mixer 155 may furthermore receive additional inputs from the playback device 161 (and in some embodiments the capture and playback configuration controller 163) which can modify the mixing of the audio signals from the sources.

The audio mixer in some embodiments may comprise a variable delay compensator configured to receive the outputs of the external microphones and the OCC microphone array. The variable delay compensator may be configured to receive the position estimates and determine any potential timing mismatch or lack of synchronisation between the OCC microphone array audio signals and the external microphone audio signals and determine the timing delay which would be required to restore synchronisation between the signals. In some embodiments the variable delay compensator may be configured to apply the delay to one of the signals before outputting the signals to the renderer 157.

The timing delay may be referred as being a positive time delay or a negative time delay with respect to an audio signal. For example, denote a first (OCC) audio signal by x, and another (external capture apparatus) audio signal by y. The variable delay compensator is configured to try to find a delay τ, such that x(n)=y(n−τ). Here, the delay τ can be either positive or negative.

The variable delay compensator may in some embodiments comprises a time delay estimator. The time delay estimator may be configured to receive at least part of the OCC audio signal (for example a central channel of a 5.1 channel format spatial encoded channel). Furthermore the time delay estimator is configured to receive an output from the external capture apparatus microphone 113, 123, 133. Furthermore in some embodiments the time delay estimator can be configured to receive an input from the location tracker 153.

As the external microphone may change its location (for example because the person wearing the microphone moves while speaking), the OCC locator 145 can be configured to track the location or position of the external microphone (relative to the OCC apparatus) over time. Furthermore, the time-varying location of the external microphone relative to the OCC apparatus causes a time-varying delay between the audio signals.

In some embodiments a position or location difference estimate from the location tracker 143 can be used as the initial delay estimate. More specifically, if the distance of the external capture apparatus from the OCC apparatus is d, then an initial delay estimate can be calculated. Any audio correlation used in determining the delay estimate may be calculated such that the correlation centre corresponds with the initial delay value.

In some embodiments the mixer comprises a variable delay line. The variable delay line may be configured to receive the audio signal from the external microphones and delay the audio signal by the delay value estimated by the time delay estimator. In other words when the ‘optimal’ delay is known, the signal captured by the external (Lavalier) microphone is delayed by the corresponding amount.

In some embodiments the mixer/render apparatus 151 may furthermore comprise a renderer 157. In the example shown in FIG. 9 the renderer is a binaural audio renderer configured to receive the output of the mixed audio signals and generate rendered audio signals suitable to be output to the playback apparatus 161. For example in some embodiments the audio mixer 155 is configured to output the mixed audio signals in a first multichannel (such as 5.1 channel or 7.1 channel format) and the renderer 157 renders the multichannel audio signal format into a binaural audio formal. The renderer 157 may be configured to receive an input from the playback apparatus 161 (and in some embodiments the capture and playback configuration controller 163) which defines the output format for the playback apparatus 161. The renderer 157 may then be configured to output the renderer audio signals to the playback apparatus 161 (and in some embodiments the playback output 165).

The audio renderer 157 may thus be configured to receive the mixed or processed audio signals to generate an audio signal which can for example be passed to headphones or other suitable playback output apparatus. However the output mixed audio signal can be passed to any other suitable audio system for playback (for example a 5.1 channel audio amplifier).

In some embodiments the audio renderer 157 may be configured to perform spatial audio processing on the audio signals.

The mixing and rendering may be described initially with respect to a single (mono) channel, which can be one of the multichannel signals from the OCC apparatus or one of the external microphones. Each channel in the multichannel signal set may be processed in a similar manner, with the treatment for external microphone audio signals and OCC apparatus multichannel signals having the following differences:

1) The external microphone audio signals have time-varying location data (direction of arrival and distance) whereas the OCC signals are rendered from a fixed location.

2) The ratio between synthesized “direct” and “ambient” components may be used to control the distance perception for external microphone sources, whereas the OCC signals are rendered with a fixed ratio.

3) The gain of external microphone signals may be adjusted by the user whereas the gain for OCC signals is kept constant.

The playback apparatus 161 in some embodiments comprises a capture and playback configuration controller 163. The capture and playback configuration controller 163 may enable a user of the playback apparatus to personalise the audio experience generated by the mixer 155 and renderer 157 and furthermore enable the mixer/renderer 151 to generate an audio signal in a native format for the playback apparatus 161. The capture and playback configuration controller 163 may thus output control and configuration parameters to the mixer/renderer 151.

The playback apparatus 161 may furthermore comprise a suitable playback output 165.

In such embodiments the OCC apparatus or spatial audio capture apparatus comprises a microphone array positioned in such a way that allows omnidirectional audio scene capture.

Furthermore the multiple external audio sources may provide uncompromised audio capture quality for sound sources of interest.

As described previously whilst the system as described above with a single OCC apparatus 141 is stable with regards to the captured audio signals. Systems which introduce multiple OCC apparatus in order to cover a larger area suffer from a potential switching problem.

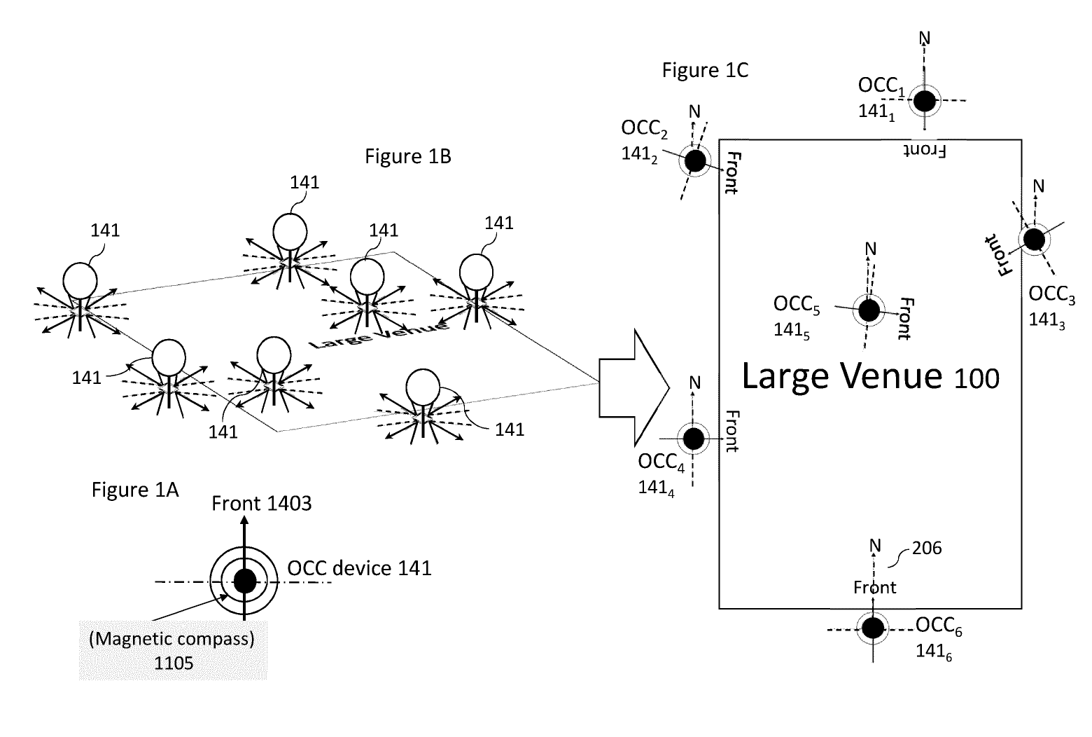

FIGS. 1a to 1c show example OCC and OCC distributions for an example venue which may not be able to be covered using a single OCC apparatus.

FIG. 1a for example shows schematically an OCC apparatus or device 141. The OCC apparatus has a ‘Front’ or reference orientation. In the following examples the OCC apparatus or device is configured to capture audio visual content and equipped with an in-device magnetic compass 1105. The magnetic compass reference axis and the media capture system reference axis 1403 is shown in FIG. 1a as being aligned. Consequently, the offset of magnetic compass (and thus magnetic North) also represents the offset of the OCC device.

FIG. 1b shows a distribution of several OCC devices around a large venue in such a manner, so as to cover a wide expanse.

FIG. 1c shows the potential issue where the offset between the reference orientations of each OCC device are not known. In FIG. 1c there are shown five OCC (OCC1 141₁ to OCC4 141₄ and OCC6 141₆) located on the periphery of the venue space looking in and a further OCC (OCC5 141₅) located within the venue. As can be seen the reference orientations of each of the OCC apparatus differ with each other. Thus should a user who is consuming (of listening to) the captured media change their ‘viewpoint’ from OCC1 141₁ to OCC₅ 141₅ there would be an abrupt switch in viewpoint orientation. Such a behaviour would not be acceptable to someone experiencing the media (for example the spatially resolved audio signals would likely ‘click’ in an artificial manner to the new viewpoint).

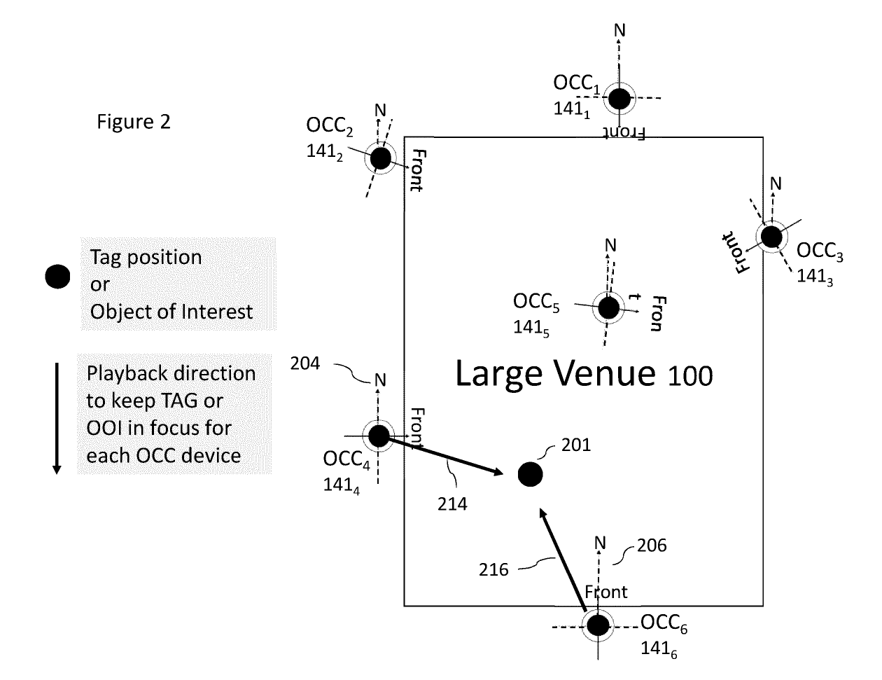

This effect can be visualised with respect to FIG. 2. FIG. 2 shows the venue 100 and the OCC distribution as shown in FIG. 1c but furthermore shows an example external capture apparatus 201 (or object of interest OOI) located within the venue. In this example a user experiencing the venue and following an external capture apparatus 201 within the venue initially from OCC1 141₁ may ‘hear’ the source associated with the external capture apparatus 201 as if it is coming from in front and slightly to the right of the listener. In other words the source is located in front and to the right of the reference orientation. However by switching to OCC5 141₅ the source would abruptly switch such the listener would hear the source coming from the rear right quadrant and as such would be confused with respect to why the source has moved abruptly.

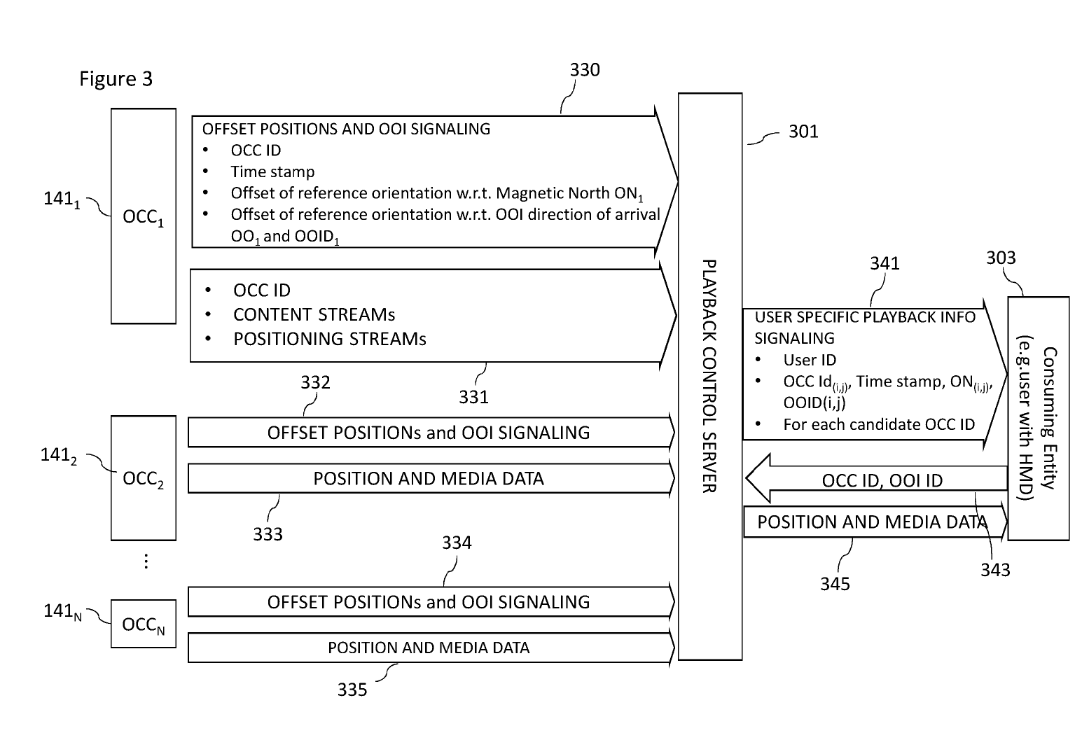

With respect to FIG. 3 an example system and apparatus employed in embodiments as described herein to mitigate such switching effects are shown.

FIG. 3 for example shows schematically N OCC (OCC1 141₁, OCC2 141₂, . . . ,OCCN 141_{N}), a playback control server 301 and a consuming entity 303. In this example the playback control server (PCS) 301 may be considered to be similar to the mixer/renderer shown in FIG. 9 but with additional functionality as described herein. Furthermore the consuming entity may be considered to be similar to the playback apparatus 161 shown in FIG. 9.

The OCC apparatus 141 in some embodiments is configured to determine the following characteristics. Firstly the OCC apparatus is configured to determine a OCC ID value. The OCC ID value uniquely identifies an OCC device within the full system. This value may be determined in any suitable manner. Furthermore the OCC apparatus 141 is configured to determine a time value from which a time stamp or time stamp value associated with the time when the signals are sent. The OCC apparatus may furthermore determine an offset value identifying the difference between the OCC apparatus reference axis with respect to a common reference axis. In the following embodiments the common reference axis is determine by an electronic compass and thus the offset value ONᵢ (for the i'th OCC) is the offset between the OCC reference orientation and magnetic North.

In some embodiments (and as described previously) the OCC is further configured to locate the external capture apparatus or object of interest (OOI) and furthermore determine the orientation of these OOI relative to the OCC reference orientation. This orientation information OOᵢ and an OOI identifier value identifying the external capture apparatus may also be sent with the OCC ID value, time stamp and the offset of reference orientation ONᵢ value to the PCS 301. In some embodiments the OCC is configured to determine the orientation of these OOI with respect to the common reference axis and transmit this information rather than the ‘relative to the OCC reference’ orientation value.

In other words the OCC is configured to generate or determine and output to the PCS 301 the offset position and OOI information. This is shown for OCC1 in step 330.

Furthermore this is shown in FIG. 3 for OCC2 by step 332 and for OCCN by step 334.

The OCC furthermore may be configured to generate media content such as the captured spatial audio signals from a microphone array. This media content may furthermore be transmitted to the PCS 301.

In some embodiments of the implementation, the OCC apparatus comprises a gyroscope and/or altimeter in addition to the compass. In these embodiments in addition to the signalling information described above, the position of the OCC apparatus in 3D space can be determined and signalled to the PCS.

Consequently, the reference offset in 3D can be obtained between the OCC apparatus.

The operation of generating/determining the content and positioning information and transmitting it to the PCS with respect to OCC1 141₁ is shown in FIG. 3 by step 331.

Furthermore these operations are is shown in FIG. 3 for OCC2 by step 333 and for OCCN by step 335.

This system is therefore configured to enable switching of viewpoints across different OCC apparatus or capture devices without causing abrupt or unexpected view point changes.

In some embodiments the playback control server (PCS) 301 is configured to receive the OCC ID, which uniquely identifies an OCC device in the full system, the time stamp when the signal was sent and the offset of reference axis with respect to magnetic North ONi. This information may be used by the PCS 301 to create an offset guidance signal for the end user consuming entity (playback apparatus) 303. The guidance information may for example comprise an identifier identifying the consuming entity or user thereof, the available OCC identifiers, orientation information and object of interest orientation information.

The generation and transmitting of the guidance signal is shown in FIG. 3 by step 341.

The consuming entity 303 can be the end user who is watching/listening to the content for example with a head mounted display. The consuming entity may receive the guidance information and display such information to the user via a suitable user interface. Furthermore the consuming entity may be configured to enable a user input to be made to select the ‘viewpoint’. In other words the user may select an OCC from which the content is to be captured. The consuming entity may furthermore be configured to select an object on interest the user is interested in. In other words the user may select an OOI identifier.

The consuming entity may furthermore determine other consumption parameters, for example a head tracking value from the head mounted display/headphones from which the content is being output.

This information may be transmitted back to the PCS 301.

The operation of generating/determining OCC ID and OOI ID values is shown in FIG. 3 by step 343.

The PCS 301, in some embodiments may operate as a streaming server with respect to the media content.

The PCS 301 may thus receive the output values from the consuming entity 303 (or end user device). Thus for example the PCS may receive information for a switch of viewpoint with respect to a possible pair of OCC devices. For example, if the user is currently on view point corresponding to OCC1, all the other OCC devices can be candidate switch devices.

The PCS may be configured such that when the user operating the consuming entity switches from OCC1 to OCC5 the viewing angle is chosen based on the switching policy adopted.

For example where the switching policy is a minimal change in viewing angle policy, the PCS may enable a start playback direction in OCC5 to be calculated as follows:

Current viewing angle: ON1+Offset of current view from Front (for example as provided by the headtracker).

For sake of simplicity if we assume Offset of current view as 0 (in other words the headtracker function is switched off or straight ahead) then

Current viewing angle=ON1

New viewing angle (after switching to OCC5)=ON1+ON5.

In some embodiments the external sources (objects of interest) are also tracked. The PCS may thus be configured to compensate for the switching in order enable a seamless following of an object of interest. For example, where an OOI is tracked continuously with a suitable mechanism. The angular position of the OOI with respect to each of the OCC devices is known. In this situation, the start playback orientation is such that the tracked OOI is always visible while switching the view.

In such an example the offset of the OOI with respect to the reference axis of the OCC is signalled by the OCC devices to the PCS. The PCS signals the offset angles between the different OCC pairs to maintain seamless following of OOI.

The content from the processed media may then be transmitted to the consuming entity as shown in FIG. 3 by step 345.

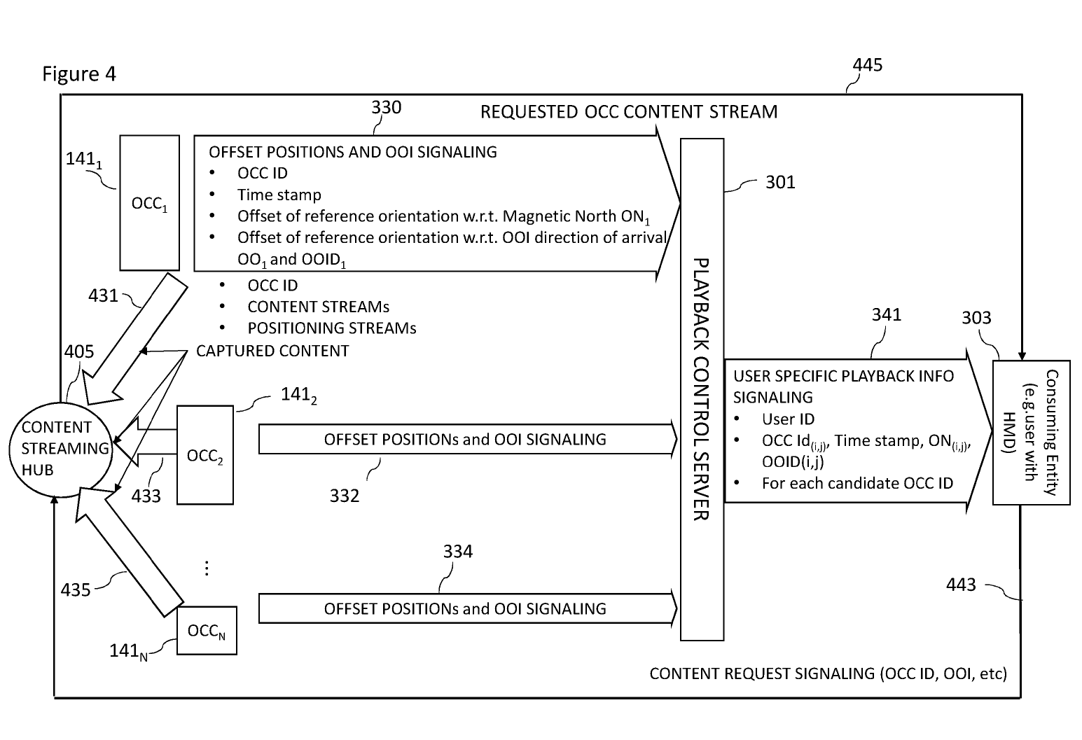

FIG. 4 shows a further system wherein the content streaming and requesting is performed between the consuming entity (end user devices) 303 and a content (streaming) hub 405. In such embodiments the PCS 301 only provides user specific playback control signalling.

In other words the OCC apparatus transmit the offset positions and OOI signalling information to the PCS 301 (as shown in steps 330, 332 and 334) and transmit the content to the content (streaming) hub 405 (as shown in steps 431, 433, and 435).

The content request signalling may then be transmitted from the consuming entity 303 to the content streaming hub 405 as shown in step 443.

The content may then be filtered/mixed/rendered/processed and transmitted from the content streaming hub 405 to the consuming entity 303 as shown in step 445.

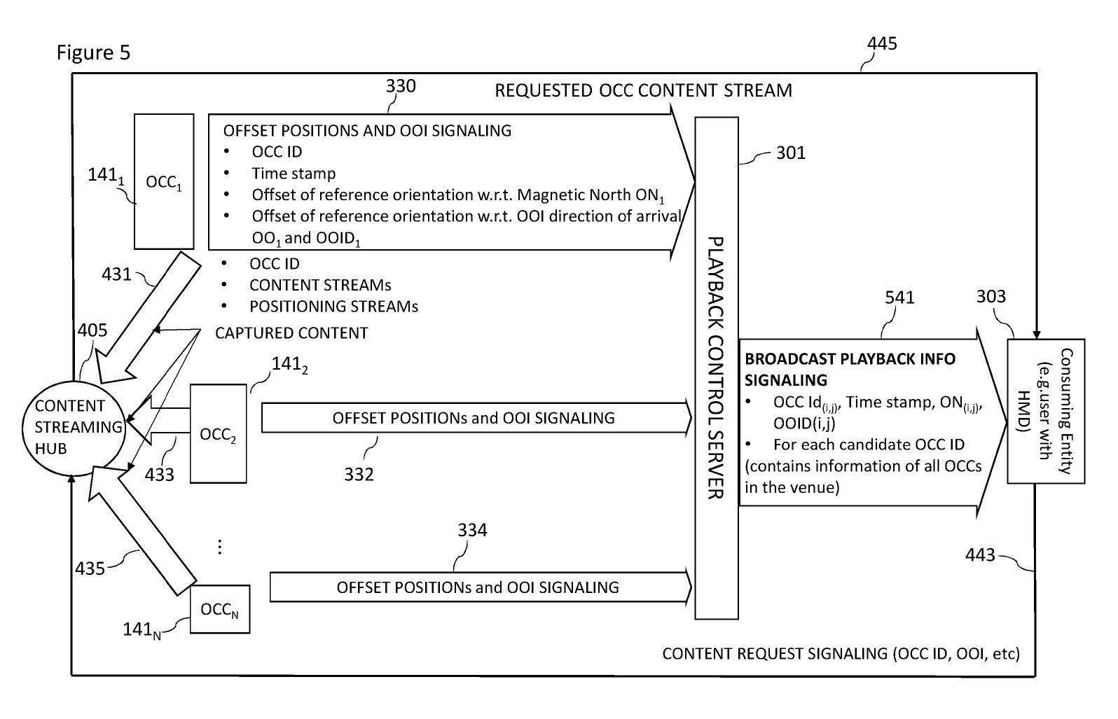

FIG. 5 shows a system similar to FIG. 4 but where the PCS is configured to generate a playback control broadcast service, which any consumer entity 303 or end user device can tune into and receive the offset information about all the OCC devices in the system.

The generation and broadcast of playback information signalling is shown in FIG. 5 by step 541.

In some embodiments the systems such as shown in FIGS. 4 and 5 have the benefit of generating and working only with metadata information. Consequently such systems may be converted into a peer-to-peer configuration between OCC devices.

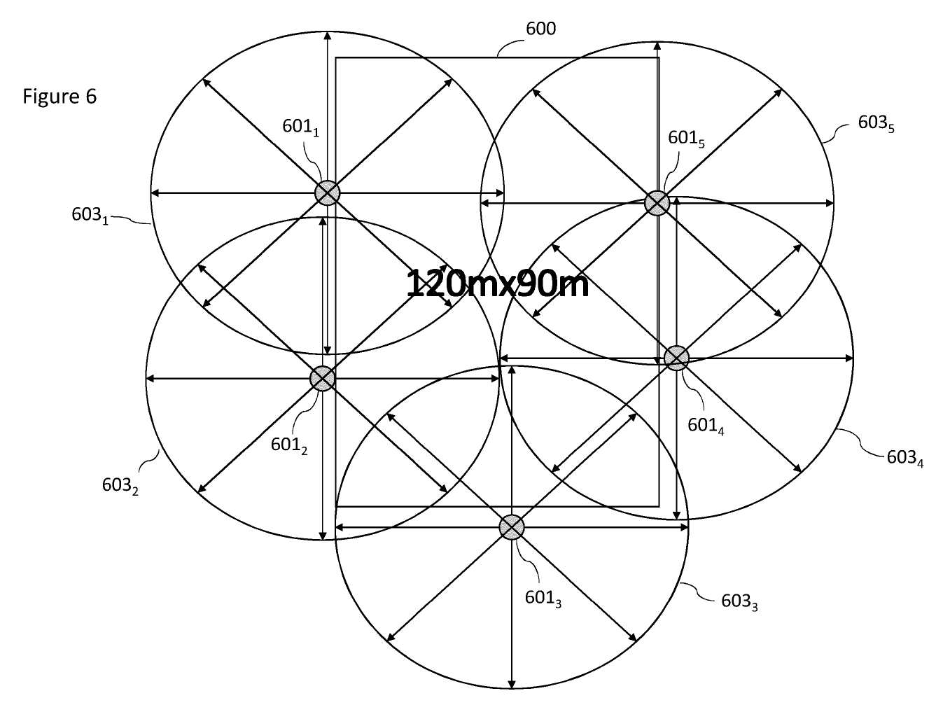

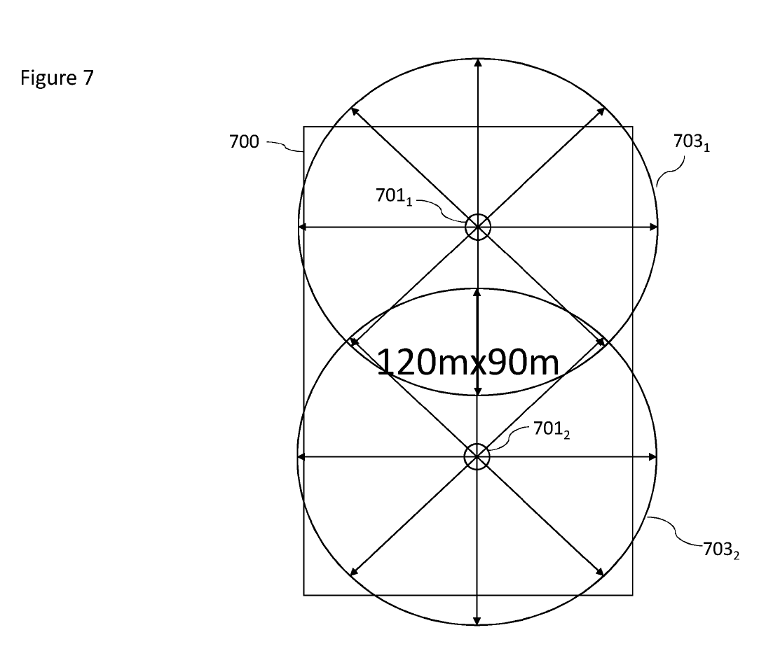

With respect to FIGS. 6 and 7 are shown example OCC distributions for OCC apparatus 601 each of which has an effective capture range 603.

Assuming a circular coverage space for each of the OCC apparatus coupled with omnidirectional positioning having a range of Rm radius. Then the area covered by single OCC=Pi*R̂2. FIG. 6 for example shows a perimeter configuration where the OCC apparatus 601 may only be placed the perimeter of the venue 600. FIG. 7 shows a in-venue configuration where the OCC apparatus 701 can be placed within the venue space. The ratio of the number of OCC apparatus needed between the distribution in FIGS. 6 and 7 is approximately 2.

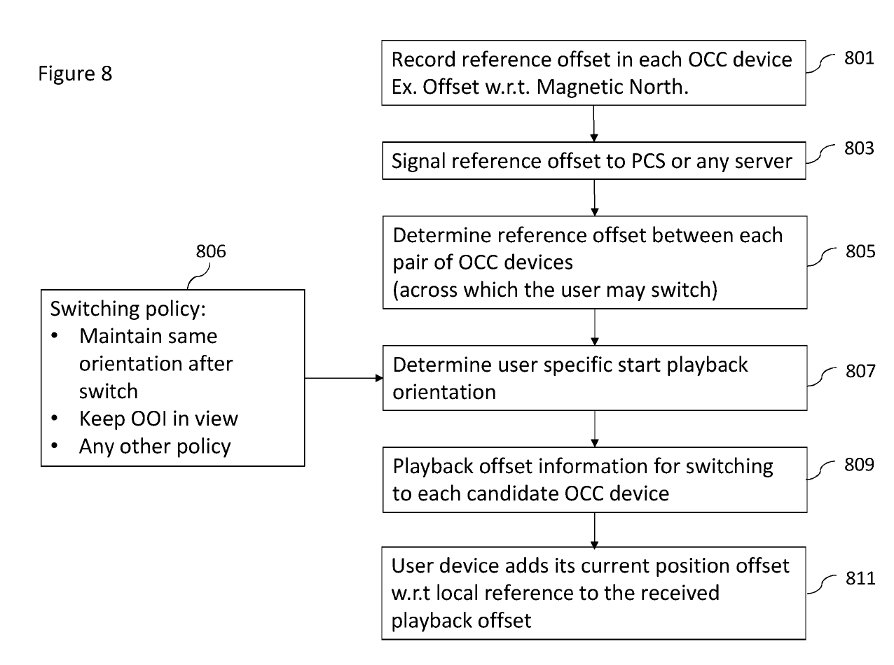

With respect to FIG. 8 is shown a summary of operations with respect to some embodiments.

The initial operation with respect to the OCC is to determine or record the reference offset with respect to magnetic north (or other common datum) orientation.

The operation of determining or recording the reference offset of the OCC with respect to magnetic north (or other common datum) orientation is shown in FIG. 8 by step 801.

The reference offset may then be transmitted to a PCS or other suitable server.

The operation of transmitting the reference offset is shown in FIG. 8 by step 803.

The server or PCS may be configured to determine reference offset differences between pairs of OCC apparatus.

The operation of determining the reference offset differences is shown in FIG. 8 by step 805.

In some embodiments the PCS may furthermore determine a switching policy. For example in some embodiments the switching policy may be configured to maintain the same orientation after a switch, or may be configured to keep the OOI within the field of view or within a range of hearing orientation, or any other switching policy.

The operation of determining a switching policy is shown in FIG. 8 by step 806.

In some embodiments the switching policy may determine the user specific start playback orientation (especially when a switch between OCC apparatus is made).

The operation of determining a user specific start playback orientation is shown in FIG. 8 by step 807.

The system in some embodiments furthermore may determine or generate playback offset information which can be provided to the playback devices.

The determination or generation of the playback offset information is shown in FIG. 8 by step 809.

The user device, or playback device may receive the information and add the current position offset with respect to the local reference to a received playback offset and this may be used to control the media playback, for example to control the mixing and rendering of the audio signals to be output to the user.

The operation of adding the current position offset with respect to the local reference to a received playback offset is shown in FIG. 8 by step 811.

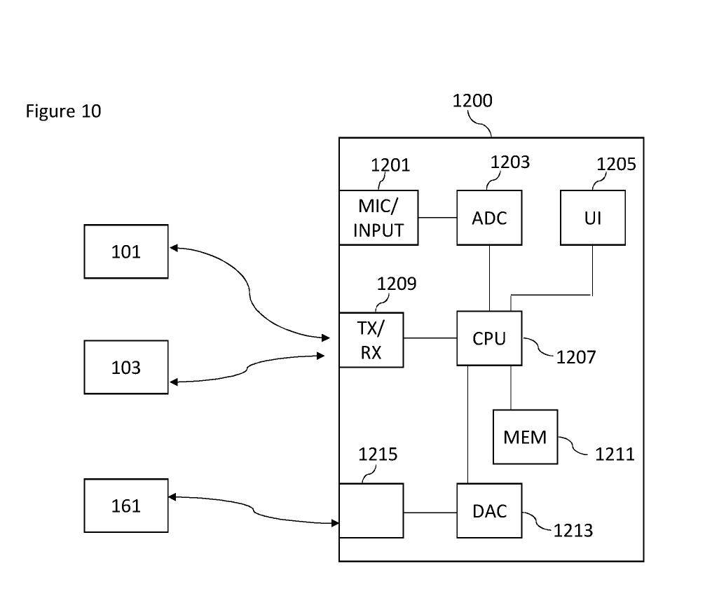

With respect to FIG. 10 an example electronic device which may be used as at least part of the external capture apparatus 101, 103 or 105 or OCC capture apparatus 141, or mixer/renderer 151 or the playback apparatus 161 is shown. The device may be any suitable electronics device or apparatus. For example in some embodiments the device 1200 is a mobile device, user equipment, tablet computer, computer, audio playback apparatus, etc.

The device 1200 may comprise a microphone array 1201. The microphone array 1201 may comprise a plurality (for example a number N) of microphones. However it is understood that there may be any suitable configuration of microphones and any suitable number of microphones. In some embodiments the microphone array 1201 is separate from the apparatus and the audio signals transmitted to the apparatus by a wired or wireless coupling. The microphone array 1201 may in some embodiments be the microphone 113, 123, 133, or microphone array 145 as shown in FIG. 9.

The microphones may be transducers configured to convert acoustic waves into suitable electrical audio signals. In some embodiments the microphones can be solid state microphones. In other words the microphones may be capable of capturing audio signals and outputting a suitable digital format signal. In some other embodiments the microphones or microphone array 1201 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphones can in some embodiments output the audio captured signal to an analogue-to-digital converter (ADC) 1203.

The device 1200 may further comprise an analogue-to-digital converter 1203. The analogue-to-digital converter 1203 may be configured to receive the audio signals from each of the microphones in the microphone array 1201 and convert them into a format suitable for processing. In some embodiments where the microphones are integrated microphones the analogue-to-digital converter is not required. The analogue-to-digital converter 1203 can be any suitable analogue-to-digital conversion or processing means. The analogue-to-digital converter 1203 may be configured to output the digital representations of the audio signals to a processor 1207 or to a memory 1211.

In some embodiments the device 1200 comprises at least one processor or central processing unit 1207. The processor 1207 can be configured to execute various program codes. The implemented program codes can comprise, for example, SPAC control, position determination and tracking and other code routines such as described herein.

In some embodiments the device 1200 comprises a memory 1211. In some embodiments the at least one processor 1207 is coupled to the memory 1211. The memory 1211 can be any suitable storage means. In some embodiments the memory 1211 comprises a program code section for storing program codes implementable upon the processor 1207. Furthermore in some embodiments the memory 1211 can further comprise a stored data section for storing data, for example data that has been processed or to be processed in accordance with the embodiments as described herein. The implemented program code stored within the program code section and the data stored within the stored data section can be retrieved by the processor 1207 whenever needed via the memory-processor coupling.

In some embodiments the device 1200 comprises a user interface 1205. The user interface 1205 can be coupled in some embodiments to the processor 1207. In some embodiments the processor 1207 can control the operation of the user interface 1205 and receive inputs from the user interface 1205. In some embodiments the user interface 1205 can enable a user to input commands to the device 1200, for example via a keypad. In some embodiments the user interface 205 can enable the user to obtain information from the device 1200. For example the user interface 1205 may comprise a display configured to display information from the device 1200 to the user. The user interface 1205 can in some embodiments comprise a touch screen or touch interface capable of both enabling information to be entered to the device 1200 and further displaying information to the user of the device 1200.

In some implements the device 1200 comprises a transceiver 1209. The transceiver 1209 in such embodiments can be coupled to the processor 1207 and configured to enable a communication with other apparatus or electronic devices, for example via a wireless communications network. The transceiver 1209 or any suitable transceiver or transmitter and/or receiver means can in some embodiments be configured to communicate with other electronic devices or apparatus via a wire or wired coupling.

For example as shown in FIG. 10 the transceiver 1209 may be configured to communicate with a playback apparatus 103.

The transceiver 1209 can communicate with further apparatus by any suitable known communications protocol. For example in some embodiments the transceiver 209 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the device 1200 may be employed as a render apparatus. As such the transceiver 1209 may be configured to receive the audio signals and positional information from the capture apparatus 101, and generate a suitable audio signal rendering by using the processor 1207 executing suitable code. The device 1200 may comprise a digital-to-analogue converter 1213. The digital-to-analogue converter 1213 may be coupled to the processor 1207 and/or memory 1211 and be configured to convert digital representations of audio signals (such as from the processor 1207 following an audio rendering of the audio signals as described herein) to a suitable analogue format suitable for presentation via an audio subsystem output. The digital-to-analogue converter (DAC) 1213 or signal processing means can in some embodiments be any suitable DAC technology.

Furthermore the device 1200 can comprise in some embodiments an audio subsystem output 1215. An example, such as shown in FIG. 10, may be where the audio subsystem output 1215 is an output socket configured to enabling a coupling with the headphones 161. However the audio subsystem output 1215 may be any suitable audio output or a connection to an audio output. For example the audio subsystem output 1215 may be a connection to a multichannel speaker system.

In some embodiments the digital to analogue converter 1213 and audio subsystem 1215 may be implemented within a physically separate output device. For example the DAC 1213 and audio subsystem 1215 may be implemented as cordless earphones communicating with the device 1200 via the transceiver 1209.

Although the device 1200 is shown having both audio capture and audio rendering components, it would be understood that in some embodiments the device 1200 can comprise just the audio capture or audio render apparatus elements.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. Apparatus for capturing media comprising:
a first media capture apparatus configured to capture media;
a locator configured to receive at least one remote location signal such that the apparatus is configured to determine an audio source location associated with a tag generating the at least one remote location signal, the locator comprising an array of antenna elements arranged with a reference orientation and the audio source location associated with the tag is determined relative to the reference orientation; and
a common orientation determiner configured to determine a common datum orientation between the reference orientation and a common datum, the common datum being common with respect to the apparatus and at least one further apparatus for capturing media, such that audio source location is enabled to be determined relative to the common datum based on the common datum orientation.

2. The apparatus as claimed in claim 1, wherein the first media capture apparatus comprises at least one of:
a microphone array configured to capture at least one spatial audio signal comprising an audio source, the microphone array comprising at least two microphones arranged around a first axis and configured to capture the audio source along the reference orientation; and
at least one camera configured to capture an image with a field of view including the reference orientation.

3. The apparatus as claimed in claim 1, wherein the locator is a radio based positioning locator and wherein the at least one remote location signal is a radio based positioning tag signal.

4. The apparatus as claimed in claim 1, wherein the locator is configured to transmit the common datum orientation associated with the apparatus to a server, wherein the server is configured to determine an offset orientation between pairs of the first media capture apparatus based on the common datum orientation associated with the apparatus and a further common datum orientation associated with the at least one further apparatus.

5. The apparatus as claimed in claim 1, wherein the locator is configured to locate an audio source associated with a tag based on the reference orientation from which the tag is located and the common datum orientation so to generate an audio source location orientation relative to the common datum.

6. The apparatus as claimed in claim 1, wherein the first media capture apparatus has a capture reference orientation which is offset with respect to the reference orientation associated with the locator antenna elements.

7. The apparatus as claimed in claim 1, wherein the common orientation determiner comprises:
an electronic compass configured to determine the common datum orientation between the reference orientation and magnetic north;
a beacon orientation determiner configured to determine the common datum orientation between the reference orientation and a radio or light beacon; and
a satellite positioning system based orientation determiner configured to determine the common datum orientation between the reference orientation and a determined satellite positioning system derived position.

8. Apparatus for playback control of captured media, the apparatus configured to:
receive, from each of two or more apparatus as claimed in claim 1, the common datum orientation between the reference orientation of the respective apparatus for capturing media and the common datum, the common datum being common with respect to the two or more media capture apparatus; and
determine an offset orientation between pairs of the apparatus as claimed in claim 1 based on the common datum orientations.

9. The apparatus as claimed in claim 8, wherein the apparatus for playback control of captured media is furthermore configured to provide the offset orientation to a playback apparatus to enable the playback apparatus to control a switch between the two or more media capture apparatus.

10. The apparatus as claimed in claim 8, further configured to receive captured media from more than one apparatus wherein the apparatus is further configured to process the captured media from the two or more media capture apparatus based on the offset orientation.

11. The apparatus as claimed in claim 8, further configured to:
receive determined audio source locations from the two or more media capture apparatus;
determine a switching policy associated with a switch between a pair of the media capture apparatus; and
apply the switching policy to the location estimates for audio sources.

12. The apparatus as claimed in claim 11, wherein the switching policy comprises one or more of the following:
maintain a location orientation for an object of interest after a switch; and
keep an object of interest within a field of experience after a switch.

13. A system comprising:
a first apparatus as claimed in claim 1;
a further apparatus for capturing media comprising:
a further media capture apparatus configured to capture media;
a further locator configured to receive the at least one remote location signal such that the further apparatus is configured to determine a further audio source location associated with the tag generating the remote location signals, the further locator comprising a further array of antenna elements arranged with a further reference orientation from which the tag is located; and
a further common orientation determiner configured to determine a further common datum orientation between the further apparatus reference orientation and the common datum, the common datum being common with respect to the further apparatus and the apparatus.

14. A method for capturing media, the method comprising:
capturing media using a first media capture apparatus;
receiving at least one remote location signal;
determining an audio source location associated with a tag generating the remote location signal, the determined audio source location associated with the tag is determined relative a reference orientation;
determining a common datum orientation between the reference orientation and a common datum, the common datum being common with respect to the first media capture apparatus and at least one further capture apparatus, such that the audio source location is enabled to be determined relative to the common datum based on the common datum orientation.

15. The method as claimed in claim 14, wherein capturing media comprises at least one of:
capturing at least one spatial audio signal comprising an audio source using a microphone array comprising at least two microphones arranged around a first axis and configured to capture an audio source along the reference orientation; and
capturing an image using at least one camera with a field of view including the reference orientation.

16. The method as claimed in claim 14, wherein determining the audio source location comprises radio based positioning locating and wherein the at least one remote location signal is a radio based positioning tag signal.

17. The method as claimed in claim 14, wherein determining the audio source location comprises transmitting the common datum orientation to a server, wherein the method further comprises determining at the server an offset orientation between pairs of the first media capture apparatus based on the common datum orientation associated with the first media capture apparatus and a further common datum orientation associated with the at least one further apparatus.

18. (canceled)

19. The method as claimed in claim 14 wherein the first media capture apparatus has a capture reference orientation which is offset with respect to the reference orientation associated with the locator antenna elements.

20. The method as claimed in claim 14, wherein determining the common orientation comprises:
an electronic compass determining the common datum orientation between the reference orientation and magnetic north;
a beacon orientation determining the common datum orientation between the reference orientation and a radio or light beacon; and
a satellite positioning system based orientation determining the common datum orientation between the reference orientation and a determined satellite positioning system derived position.

21-25. (canceled)

26. The apparatus as claimed in claim 1, further comprising receiving with the at least one remote location signal at least one audio signal associated with the at least one remote location signal.
